(19) United States
(12) Patent Application Publication
(10) Pub. No.: US 2020/0352121 A1
(43) Pub. Date: Nov. 12, 2020

(54) Modular Hydroponic System

(71) Applicant: Terry U.L. Stringham, Sanford, FL (US)

(72) Inventor: Terry U.L. Stringham, Sanford, FL (US)

(21) Appl. No.: 15/930,123

(22) Filed: May 12, 2020

Related U.S. Application Data
(60) Provisional application No. 62/846,721, filed on May 12, 2019.

(51) Int. Cl. A01G 31/02; A01K 63/06; A01K 63/04

(52) U.S. Cl. CPC A01G 31/02; A01G 2031/006; A01K 63/045; A01K 63/065

(57) ABSTRACT

Accordingly, the present disclosure relates to a modular hydroponic system that may integrate various farming mechanisms. More specifically, the modular hydroponic system may utilize interconnected modules and lines to cycle nutrient-rich water to a range of plant and animal life. The modular hydroponic system may comprise aquaponic modules that may continuously process recycled water and replenish it with nutrients to facilitate growth of the plant life. With a combination of hydroponics and aquaponics, the modular hydroponic system may provide for both a farm and fisheries, allowing for the harvest of produce and fish. The modular aspect of the modular hydroponic system may allow for customization based on resources, spaces, and needs, wherein modules may be combined and substituted.

### CROSS-REFERENCE TO RELATED APPLICATION

This application claims priority to and the full benefit of U.S. Provisional Patent Application Ser. No. 62/846,721, filed May 12, 2019, and titled “MODULAR HYDROPONIC SYSTEM”, the entire contents of which are incorporated in this application by reference.

### BACKGROUND OF THE DISCLOSURE

Over 12,000 years ago, hunter-gatherers experimented with farming. This experiment meant that once nomadic societies started building communities within a small area, initially for a short period of time. During early experiments with farming, these communities grew crops with shorter turnaround times since these societies still relied on wildlife for sustenance. During this earlier time, farming took a broader definition, since it included both the domestication of plants and animals. The earliest crops that were planted where wheat, barley, peas, and lentils, amount other items. Animals like pigs, sheep, and cattle were domesticated throughout the centuries alongside local crop farming.

Agriculture evolved into a key process for society, providing society with sustenance, medicine, and stability. In the 18^{th} century, new agricultural practices like enclosure, mechanization, four-field crop rotation to maintain soil nutrients, and selective breeding brought on a new era in agriculture and led to unprecedented population growth.

Sowing plants, trees, and other agriculture in soil has been the most common practice among farmers, gardeners, and others for centuries; which takes a lot of time and energy. Trying to manage hundreds of different square feet, or even square miles can be time consuming, often resulting in strained productivity due to outside factors that can occur when planting in soil.

Currently, about 1.4 billion people around the world rely on farming or agriculture for their source of food or income. Farmers produce up to 20% of the world's food. These farmers often work long hours each and every day because of the lengthy process involved in the day-to-day management of crops and livestock.

About 50% of the world's food comes from the production of wheat, rice, and maize; and another 25% comes from potatoes, millets, sugar, soybeans, and sorghum. Wheat can take around four months just to grow in ordinary soil, provided that the soil does not get contaminated and water is able to reach the roots consistently. Maize can take anywhere from 60-100 days, and rice can take up to five months. In some cases, a farmer also has to plant and dig up each individual crop which could take days.

Crops do not receive the proper nutrients from the soil: the soil can become contaminated due to lack of conservation, the roots of the plant may not get enough water, or animals may come and consume the plant. This ultimately causes a delay in the process of planting and can easily disrupt food productivity throughout a nation if continuous.

Other types of farming have evolved over the centuries in an attempt to find effective alternatives to traditional planting methods, and, within the past few decades, hydroponics and aeroponics have become increasingly popular. In a hydroponic system, expansive plots of land are not generally required, and plants are grown in water-based, nutrient-rich solutions, typically suspending the plants in water or air. Generally, water is absorbed by plant roots that pass through the stem system. Then the water escapes into the air through the pores of leaves. Additionally, plant roots get minerals from soil or water, and their leaves draw carbon dioxide from the air while their roots take up oxygen.

### SUMMARY OF THE DISCLOSURE

Though great strides have been made in separate farming systems, each require substantial human involvement and care. Further, each separate farming type often requires specialized care and conditions. What is needed is a modular hydroponic system that may allow for a self-sustaining modular farming system. Accordingly, the present disclosure relates to a modular hydroponic system that may integrate various farming mechanisms through interconnected hydroponic modules that may be connected by a recycling irrigation system.

More specifically, the modular hydroponic system may utilize interconnected modules and lines to cycle nutrient-rich water to a range of plant life. Further, the modular hydroponic system may comprise aquaponic modules that may continuously process recycled water and replenish it with nutrients to facilitate growth of the plant life. With a combination of hydroponics and aquaponics, the irrigation system provides for both a farm and fisheries, allowing for the harvest of produce and fish.

In some aspects, the modular hydroponic system may allow for customization based on the parameters and needs of the location. For example, a small area in a cool, arid location that may need to serve a single family may have different parameters and needs than a large area in a warm, humid location that may need to serve an entire community. As another example, commercial needs may be different than for personal use.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary modular hydroponic system, according to some embodiments of the present disclosure.

FIG. 2A illustrates an exemplary primary aquaponic module, according to some embodiments of the present disclosure.

FIG. 2B illustrates an exemplary primary aquaponic module, according to some embodiments of the present disclosure.

FIG. 2C illustrates an exemplary primary aquaponic module, according to some embodiments of the present disclosure.

FIG. 3 illustrates exemplary aquaponics holding modules, according to some embodiments of the present disclosure.

FIG. 4A illustrates exemplary aeroponic module, according to some embodiments of the present disclosure.

FIG. 4B illustrates exemplary aeroponic module, according to some embodiments of the present disclosure.

FIG. 4C illustrates exemplary aeroponic module, according to some embodiments of the present disclosure.

FIG. 5A illustrates an exemplary irrigation filter system, according to some embodiments of the present disclosure.

FIG. 5B illustrates an exemplary frame for an irrigation filter system, according to some embodiments of the present disclosure.

FIG. 6A illustrates an exemplary biofilter segment of an irrigation filter system, according to some embodiments of the present disclosure.

FIG. 6B illustrates an exemplary biofilter screen, according to some embodiments of the present disclosure.

FIG. 6C illustrates a top down view of an exemplary centrifuge for a biofilter, according to some embodiments of the present invention.

FIG. 6D illustrates a side view of an exemplary centrifuge for a biofilter, according to some embodiments of the present invention.

FIG. 7 illustrates an exemplary bead filter segment of an irrigation filter system, according to some embodiments of the present disclosure.

FIG. 8 illustrates an exemplary irrigation filter system, according to some embodiments of the present disclosure.

FIG. 9A illustrates an exemplary biofilter segment of an irrigation filter system, according to some embodiments of the present disclosure.

FIG. 9B illustrates an exemplary frame for a biofilter segment of an irrigation filter system, according to some embodiments of the present disclosure.

FIG. 10 illustrates an exemplary media filter segment of an irrigation filter system, according to some embodiments of the present disclosure.

FIG. 11A illustrates an exemplary plant pod, according to some embodiments of the present disclosure.

FIG. 11B illustrates an exemplary pod container with a plant pod, according to some embodiments of the present disclosure.

FIG. 12 illustrates an exemplary floating bacteria bead, according to some embodiments of the present disclosure.

FIG. 13 illustrates an exemplary passive sub-irrigation bed, according to some embodiments of the present disclosure.

FIG. 14 illustrates exemplary mixed beds, according to some embodiments of the present disclosure.

FIG. 15 illustrates an exemplary grow plug module, according to some embodiments of the present disclosure.

FIG. 16 illustrates an exemplary fan trap, according to some embodiments of the present disclosure.

FIG. 18A illustrates side view of an exemplary hydroponic tank module, according to some embodiments of the present disclosure.

FIG. 18B illustrates front view of an exemplary hydroponic tank module, according to some embodiments of the present disclosure.

### DETAILED DESCRIPTION

Accordingly, the present disclosure relates to a modular hydroponic system that may integrate various farming mechanisms. More specifically, the modular hydroponic system may utilize interconnected modules and lines to cycle nutrient-rich water to a range of plant life. Further, the modular hydroponic system may comprise aquaponic modules that may continuously process recycled water and replenish it with nutrients to facilitate growth of the plant life.

In the following sections, detailed descriptions of examples and methods of the disclosure will be given. The description of both preferred and alternative examples though thorough are exemplary only, and it is understood that to those skilled in the art variations, modifications, and alterations may be apparent. It is therefore to be understood that the examples do not limit the broadness of the aspects of the underlying disclosure as defined by the claims.

### Glossary

Hydroponic module: as used herein refers generally to a modular system of farming without depending on soil. In some aspects, subsets of hydroponics, such as aeroponics and aquaponics, may be used to describe a hydroponic module.
Irrigation System: as used herein refers to a system for delivering nutrients and moisture to plants in a farming system. In some embodiments, an irrigation system may utilize the same water flow between different portions of the farm and for different irrigation methods.

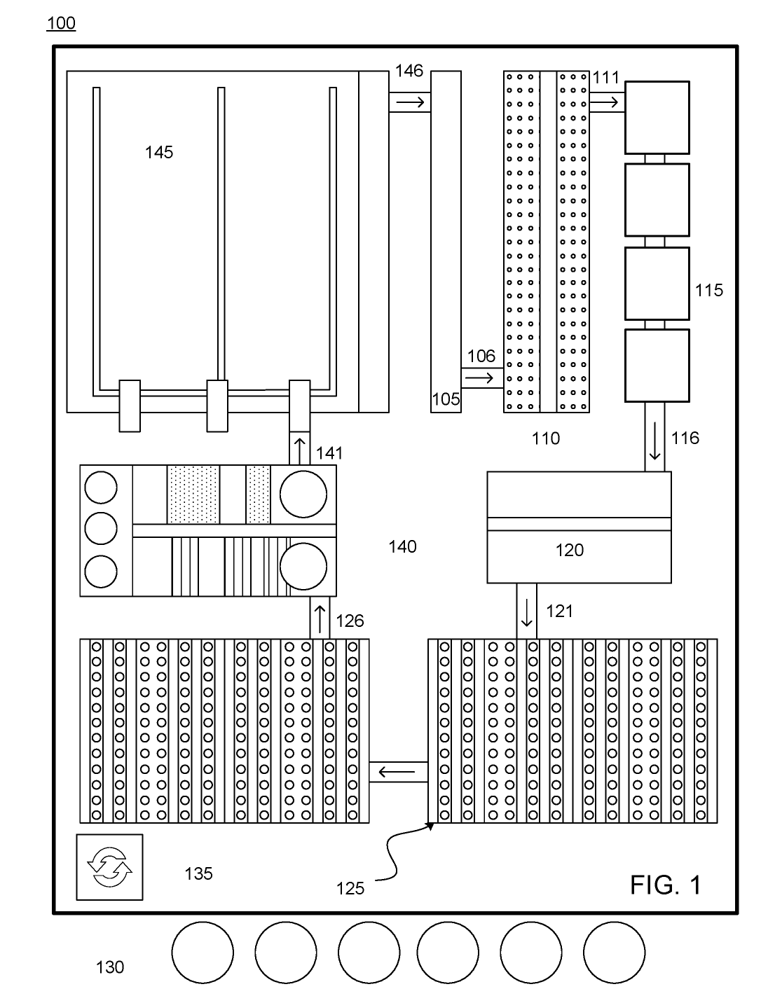

Referring now to FIG. 1, an exemplary modular hydroponic system 100 is illustrated. In some embodiments, a modular hydroponic system 100 may comprise an interconnected series of hydroponic modules wherein the hydroponic modules may be linked through a recycling irrigation system. In some aspects, the types and number of hydroponic modules may depend on a variety of factors, such as space, environments, harvesting needs, necessary human care, or resources, as non-limiting examples. In some implementations, hydroponic modules may be replaced and substituted as needed, which may allow for a flexible farming solution. In some embodiments, the order of hydroponic modules may be based on space limitations and system balance requirements.

In some aspects, each of the interconnected series of hydroponic modules may comprise an intake pipe and outflow pipe that may circulate water through the recycling irrigation system. In some embodiments, each of the interconnected series of hydroponic modules may be sequential, wherein each intake pipe may receive water from an outflow pipe in a preceding module. In some implementations, connector pipes 106, 111, 116, 121, 126, 141 may comprise a combination of intake pipes and outflow pipes. In some aspects, an intercepting pipe in the recycling irrigation system may connect water flow between modules.

In some implementations, a base modular hydroponic system 100 may comprise an aquaponic module 125, an irrigation filter module 140, a hydroponic tank module 145 and at least one type of grow bed. Different configurations of the modular hydroponic system 100 may require a range of human care. For example, some configurations may be relatively self-sustaining, where the human care may comprise harvesting the plants and fish as needed. As another example, a configuration may require a human to harvest and restock the aquaponic module 125, such as where the modular hydroponic system 100 may not comprise a holding module 120.

In some aspects, the base modular hydroponic system 100 may be contained within an enclosure, such as a greenhouse, which may allow for more control over the environment. In some embodiments, the type of enclosure for the base modular hydroponic system 100 may depend on a variety of factors, including surrounding climate, resources, necessary level of control, level of permanence, or space, as non-limiting examples. The climate may further guide the structure, such as based on typical architectural needs of various conditions.

In some embodiments, an enclosure for a temporary base modular hydroponic system 100 may be different from an enclosure for a permanent base modular hydroponic system 100. For example, the enclosure for a permanent base modular hydroponic system 100 may utilize a steel beam structure and the enclosure for a temporary base modular hydroponic system 100 may utilize a durable plastic frame, which may be collapsible or able to be disassembled. Where the external climate may be harsh, such as extremely cold, hot, wet, the enclosure may comprise stronger walls. For example, where the external climate is cold, the walls may be thick and insulated with at least a partial transparency to allow sunlight to heat the enclosure.

In some embodiments, the modular hydroponic system 100 may comprise a variety of plant bed modules, such as hydroponic tank modules 145, vine bed modules 105, an aeroponic module 110, and mixed bed modules 115, wherein the plant bed modules may allow for different plant types to be farmed simultaneously. In some aspects, the vine bed modules 105 may comprise one or more plant vine types. In some implementations, the mixed bed modules 115 may include a variety of plants, wherein each mixed bed module 115 may support plants with similar farming requirements, such as those related to moisture, sunlight, water, and nutrients, as non-limiting examples. In some embodiments, the mixed bed modules 115 may comprise a variety of plant bases, such as soil or clay pellets, which may allow for a range of water saturation.

In some implementations, the aeroponic module 110 may comprise walls of plant sockets, which may direct exposed roots toward a central water source. In some aspects, the roots of plants in the aeroponics module may be periodically misted with nutrients. In some embodiments, the hydroponic tank module 145 may comprise a water base with a series of grow beds above the waterline, wherein the roots of plants within the grow beds may be proximate to or submerged in the water. In some aspects, the plants may be spaced out evenly to grow and to help them grow.

In some embodiments, a irrigation filter module 140 may be used to keep the water fresh throughout the irrigation system. In some implementations, the demineralization module 140 may be responsible for maintaining a balanced water supply that allows a range of plants and fish to thrive in each of the modules. In some aspects, the demineralization module 140 may remove excess precipitate and bacteria from the water.

In some embodiments, the modular hydroponics system 100 may comprise a holding module 120 that may interface with an aquaponics module 125, wherein the holding module 120 and the aquaponics modules 125 may exchange fish at different maturity stages. In some embodiments, the holding module 120 may house the fish in fry and juvenile stages, and the aquaponics module 125 may host the fish in adulthood until they reach a threshold size, which may make the fish available for consumption. In some implementations, the aquaponics module 125 may comprise a series of grow beds above the fish tank, wherein nutrient-rich water may be cycled through the grow beds and recollected.

In some aspects, an environment regulator module 135 may monitor predefined climate parameters within the modular hydroponics system 100. The predefined climate parameters may comprise temperature, moisture, sunlight, pressure, humidity, and air flow, as non-limiting examples. In some embodiments, the environment regulator module 135 may regulate the climate to maintain optimum climate parameters. In some implementations, the environment regulator module 120 may be programmed with the desired climate parameters. In some aspects, the environment regulator module 120 may be in communication with other module monitoring systems, which may allow the environment regulator module 120 to regulate the climate based on real time feedback from the other module monitoring systems.

In some embodiments, the modular hydroponic system 100 may be contained within a controlled environment greenhouse. Having a controlled environment may allow for farming of produce and fish that may not be suitable for the conditions of the location. In some implementations, an environment regulator module 130 may control the humidity within the greenhouse in part by removing excess moisture and converting it to water for the modular hydroponic system 100. In some embodiments, the environment regulator module 130 may collect excess moisture and integrate the water back into the modular hydroponic system 100.

In some aspects, the water supply may be supplemented with passively collected rain water, such as through rain collection modules 130. The rain collector 130 may be used to collect rain water, but is not limited to only rain water, and may also be used for distilled, or any other water that may be added to the rain collection modules 130. In some embodiments, the water supply may be supplemented by moisture extracted from the ambient air within the greenhouse, such as through an environment regulator module 135. In some aspects, the water supply may be supplemented by both a rain collection module 130 and an environment regulator module 135, which may maximize the water supply. In some embodiments, rain collection modules 130 may not be sufficient, such as in very arid environments.

In some implementations, the rain collection modules 130 may collect other types of precipitation, such as snow, wherein a heating module (not shown) may be paired with the rain collection modules 130 to allow for the collection of water. In some environments, the cold may be a concern for the circulation of water, and heating modules may be dispersed throughout the modular hydroponic system 100 to reduce any chance of freezing and to regulate temperature where it may be critical for a module to thrive. For example, a fish holding 120 and the primary aquaponic tanks 125 may thrive within a ten-degree temperature range, so it may be necessary to actively regulate the temperature of the water in those locations. In some aspects, the heating modules may be solar powered.

As an illustrative example, a hydroponic module 145 and an aquaponic module 125 may monitor algae content of the water, wherein some algae may be useful for nutriments for the fish and an excess of algae may negatively impact the oxygen levels of the water. The environment regulator module 135 may monitor temperature and sunlight exposure for the climate. Over time, a comparison of environment regulator module 135 parameter data and aquaponic module 125 parameter data may correlate an increase in sunlight exposure, temperature, and humidity to an increase in algae.

A decrease in temperature may offset some of the increase in algae growth caused by sunlight exposure, and a decrease in sunlight exposure may offset some of the increase in algae growth caused by increased humidity. Accordingly, as an increase in sunlight exposure is detected, such as during longer days or where an exterior cover may have been removed, the environment regulator module 135 may maintain a lower temperature to reduce algae growth. Similarly, as a water temperature falls below a certain threshold, the regulator module 135 may communicate with a heating module, which may increase the water temperature.

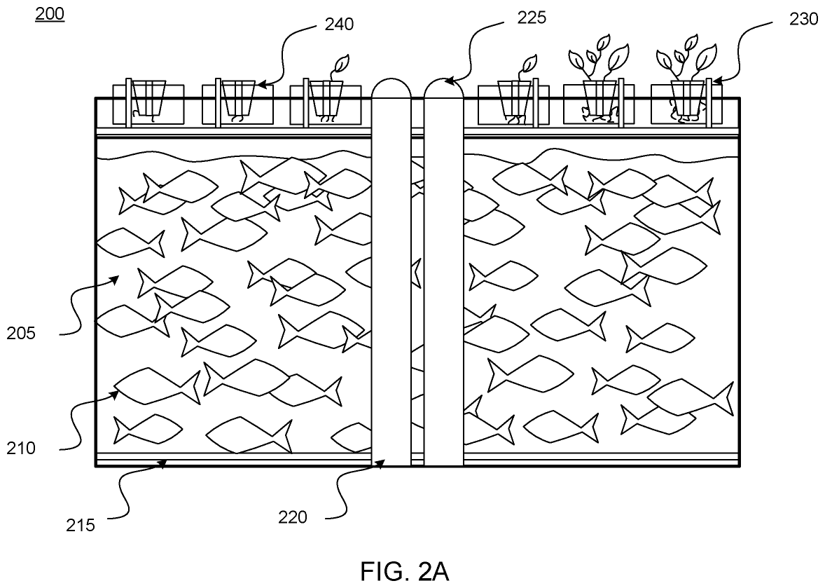

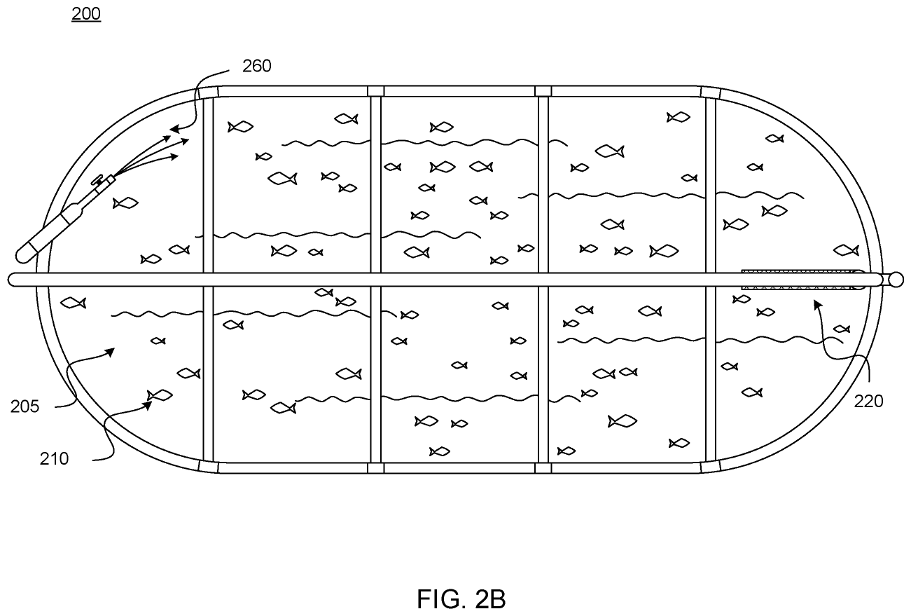

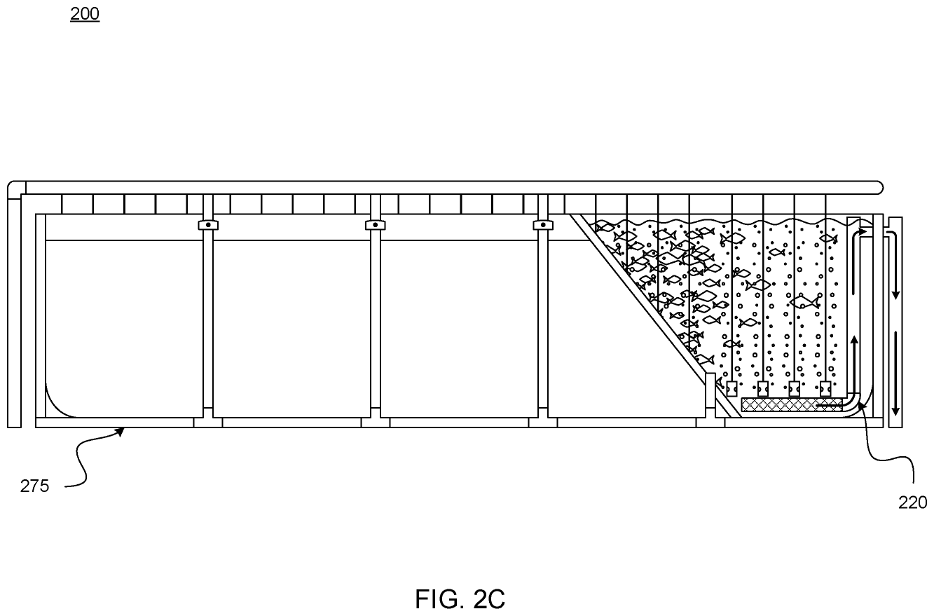

Referring now to FIGS. 2A-2C, an exemplary aquaponic module 200 is illustrated. In some aspects, the aquaponic fish tank 205 may contain fish for a predefined duration and stage of growth. In some embodiments, the aquaponic module 205 may add nutrients to the water supplied through a circulation line 225, wherein the nutrient-rich water may be circulated throughout the modular hydroponic system. In some implementations, the nutrient-rich water may be pumped through an irrigation line 230 that may be used to nourish a series of plant pods 240. In some embodiments, the plants may filter out ammonia, which may be toxic to the fish, and the water may be passed through the aeration line to be circulated back into the aquaponic fish tank 205.

In some aspects, the fish 210 may comprise one or more species that may coexist within the same or similar environments. The size of the fish may be dependent on the capacity of the aquaponic fish tank 205 and the ability to maintain a sustaining biomass. In some embodiments, the fish may be sufficient size to provide nutrients to the water and continue the growth of the population. In some aspects, the fish may be limited to a maximum size before being removed from the module for consumption.

In some embodiments, the aquaponics fish tank 205 may comprise a fry screen 215, which may limit the entry of fish prior to adulthood, particularly at the fry stage. In some implementations, the fry screen 215 may comprise a water tolerant material. In some aspects, an aeration line 220 may help oxygenate the water. In some embodiments, one or more of the water lines may comprise a water-resistant material, such as PVC, rubber, stainless steel, as non-limiting examples. The circulation line 225 may replenish water back into the aquaponic fish tank 205, which may allow for a flow of nutrient-rich water through the modular hydroponic system. The irrigation line 230 may help get direct water onto the plants, and it may also have a direct line from the circulation line to get the most nutrient water to the plants.

In some aspects, the aquaponic module 200 may comprise a continuous-flow solution, the nutrient-rich water may continuously flow through the irrigation lines 230 past the roots of the plants. In some embodiments, continuous flow may allow for adjustments at modules with tanks, which may provide for easier regulation of the water attributes.

In some embodiments, an aquaponic module 200 may comprise a frame 275 that may provide structure. In some aspects, an aeration line 220 may be located on the sides of the device, which may allow for a current that limits the risks associated with stagnant water. In some implementations, an aeration line 220 may run along the base of the aquaponic module 200, sending bubbles into the water 260. In some embodiments, this may help keep the water cleaner and filtered for longer periods of time without being manually attended to. For example, in combination with the recycling irrigation system, the water may aerate for weeks or months without a user manually treating the water or filtering it outside of what may occur in an irrigation filter module.

In some aspects, aeration devices may be built into the frame 275 to save space and allow for the device to be moved easier without exposing or damaging loose parts. In some embodiments, the frame 275 may be easily constructed and deconstructed, which may allow for construction of a modular hydroponic system in a short amount of time. In some implementations, the frame 275 may be adjusted to accommodate for various spaces and capacities.

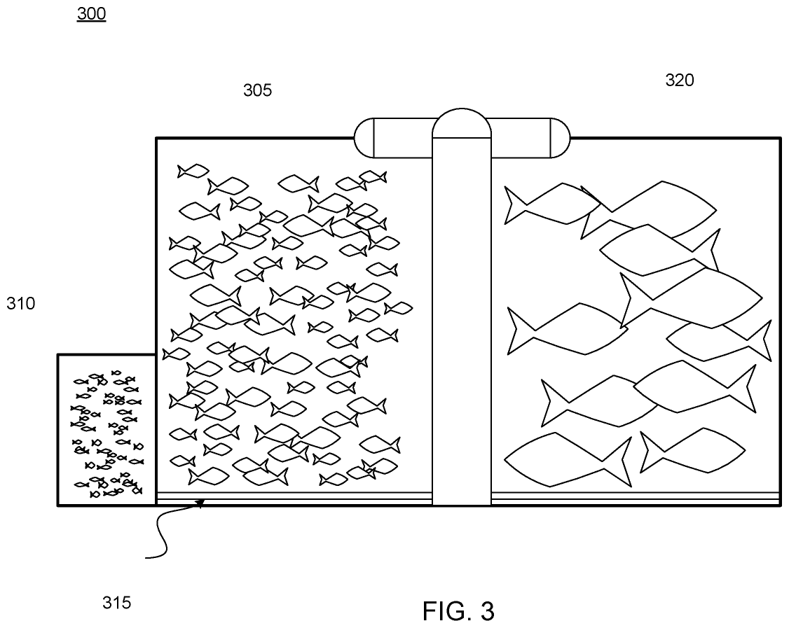

Referring now to FIG. 3, exemplary holding modules 300 are illustrated. In some aspects, the holding modules 300 may separately contain fish at different maturity stages. In some embodiments, a fry tank 310 may contain fish at the fry stage until they reach the juvenile stage, when they be migrated to the juvenile tank 305. In some implementations, once in adulthood, the fish may be migrated to a tank in an aquaponics module, where they may stay until they reach a threshold size. After reaching the threshold size, the fish may be transferred to the export tank 320, where they may be ready for removal and consumption. In some aspects, a fry screen 315 may be placed at entry points to limit the ability of fries to pass through the water lines.

In some aspects, the biomass of fish in the modular hydroponic may be maintained near maximum capacity. In some embodiments, the fish stocking process may vary depending on the modular hydroponic system. For example, the stocking process may comprise sequential rearing, wherein the aquaponic module may contain fish at multiple maturity levels. Mature fish may be hand harvested and replaced. In some embodiments, the hand harvested fish may be temporarily held in the holding module 300. As another example, stock splitting may allow for rearing the fish in the holding modules 300 and moving the mature fish to the aquaponic module through a series of pumps, screens, and lines.

As a still further example, the holding modules 300 may comprise multiple rearing units, where fish may be reared and maintained separately at each stage. In some embodiments, such as with multiple rearing units, the modular hydroponic system may comprise a plurality of aquaponic modules and holding modules 300, wherein each aquaponic module and holding module 300 may comprise different stages of fish. In some aspects, a holding module 300 may be changed to an aquaponic module when the fish reach a threshold maturity.

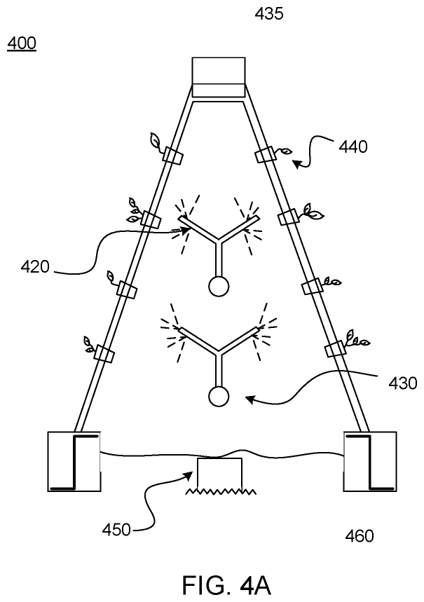

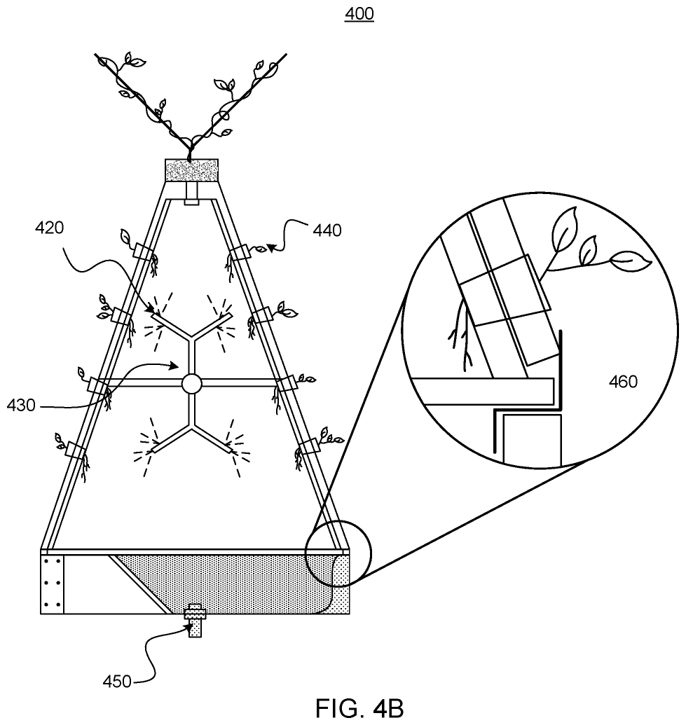

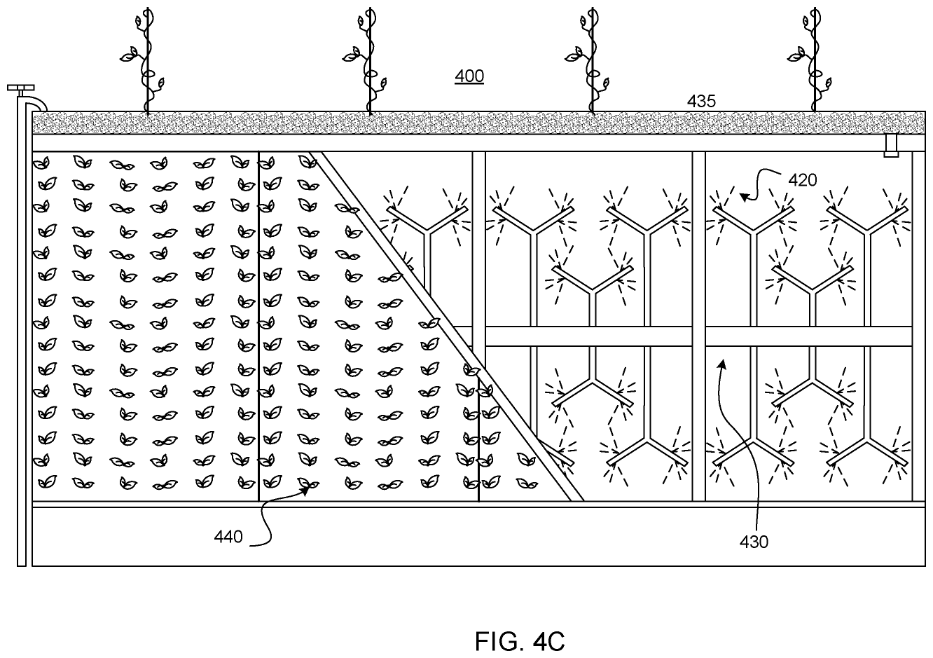

Referring now to FIGS. 4A-4C, an exemplary aeroponic module 400 is illustrated. In some aspects, an aeroponic module 400 may comprise opposite angled walls of cavities for plant pods 440, wherein the plant pods 440 may be place within the cavities so that plant roots may be face inward. In some embodiments, the angled walls may extend outward and downward from an irrigation trough 435. In some implementations, the irrigation trough 435 may comprise a plant bed that may depend on a variety of farming techniques, such as aeroponics, hydroponics, static solution, or traditional soil, as non-limiting examples.

In some aspects, the aeroponic module 400 may comprise one or more irrigation lines 430 that may mist nutrient-rich water onto the roots of the plant pods. In some embodiments, the walls of the aeroponic module 400 may be anchored utilizing a z-bar anchoring system 460, which may stabilize the aeroponic module 400. In some implementations, the z-bar anchoring system 460 may contain and direct excess water from the plant pods 440, irrigation trough 435, and the irrigation lines 430 to the recollection line 450, which may circulate the water back into the modular hydroponics system. In some aspects, the z-bar anchoring system may allow for simple set up of the aeroponic module 400 without requiring extensive construction experience.

The mister 420 may mist water onto the plants to get them more nutrients. The water that may be misted may include more nutrients than normal water to help the plants grow. The mister 420 may also rotate to get different plants and areas of the aeroponic system, there may also be more than one mister on the aeroponic module 400. The irrigation line 430 may be run through the irrigation trough 435 and into the mister 420. The irrigation line 430 may have water travel through it and into the mister 420, so that the mister 420 may spread the water on to the plants.

The irrigation trough 435 may include numerous plants, and these plants may all get misted by water from the mister 420. The irrigation trough 435 may hold a certain amount of plants, and these plants may be held in the plant pod 440. The plant pod 440 may hold at least one plant at a time but is not only limited to one plant. The recollection line 450 may also transfer this water back into the irrigation line 430. In some embodiments, the plants may be directly inserted into the wall without a frame or pot. This may allow for the complete exposure of the roots to the mister 420.

In some aspects, the aeroponic module 400 may have separate systems within the aeroponic module 400, such as plant pods 440 in a walled portion and an irrigation trough 435 located on the top. In some embodiments, the plant pods 440 may be separated underneath the surface of the irrigation trough 435. In some aspects, the irrigation line 430 may run from the surface of the irrigation trough 435 throughout all-inclusive systems underneath the surface. In some aspects, the separation of the systems may be with a solid separation bar or wall located underneath the irrigation trough. In some implementations, the mister 420 may reach the irrigation trough 435 providing some moisture.

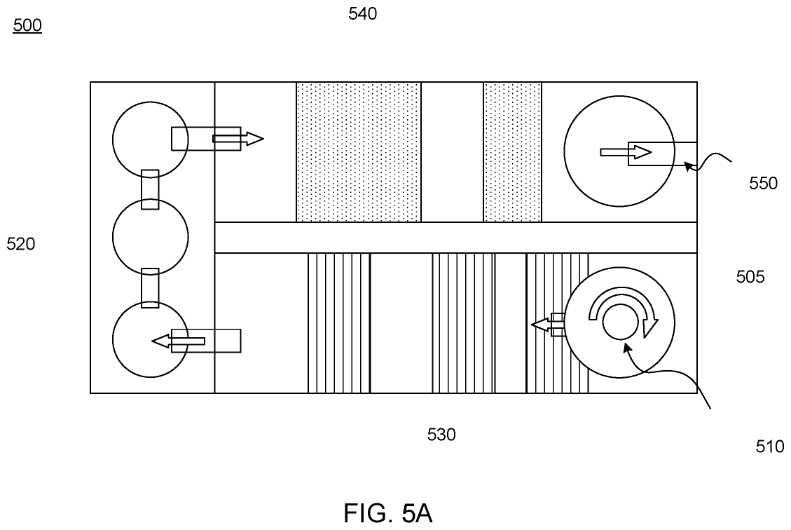

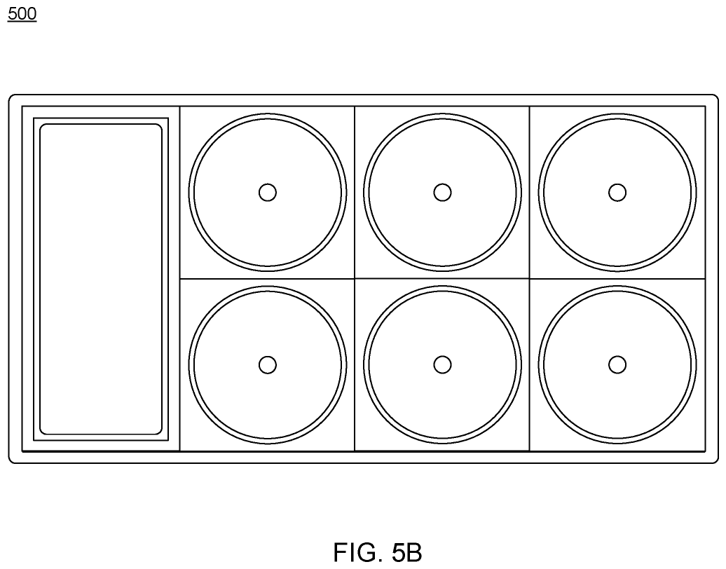

Referring now to FIGS. 5A-5B, an exemplary irrigation filter module 500 is illustrated, wherein the irrigation filter module 500 may function to maintain a balance of nutrients and bacteria. In some aspects, the recycled water may be naturally balanced throughout the modular hydroponic system but still may accumulate an excess of precipitate and bacteria that may need to be actively removed. In some implementations, the water may enter into an irrigation filter module 500 through an incoming line 510 to a spin filter 505 that may begin separating the denser components within the water through centripetal force.

In some embodiments, a demineralization module 520 may collect and remove minerals that may have been separated from the spin filter 505. In some aspects, a biofilter segment 530 may capture excess bacteria and other pollutants. In some implementations, the biofilter segment 530 may capture other excess components, such as harmful chemicals, silt, or surface runoff, as non-limiting examples. In some aspects, a bead filter segment 540 may capture larger materials in the water such as fish waste, algae, or other precipitate, as non-limiting examples. In some embodiments, once the water passes through the irrigation filter module 500, the treated water may exit through a recycling line 550 that may direct the water to the next module within the modular hydroponic system.

In some implementations, an irrigation filter module 500 may comprise a frame 500 that may contain the components in a space-effective platform. In some implementations, the frame 500 may allow for a modular arrangement of the components within the irrigation filter module 500. In some aspects, the frame may allow for a range of layouts that may be adjusted based on space and configuration requirements. For example, the frame 500 may be moved to a smaller area, and it may be taken apart and fitted to accommodate a smaller area without damaging any of the interior components. In some aspects, the frame 500 may break off into different parts to house different components in different areas. For example, if the components need to be placed into different locations or in a different order, the frame 500 may be deconstructed and reconstructed with the components to accompany them in their new location.

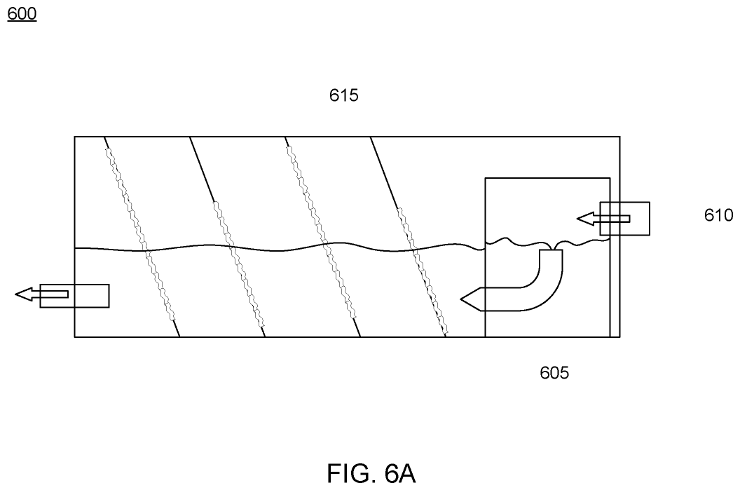

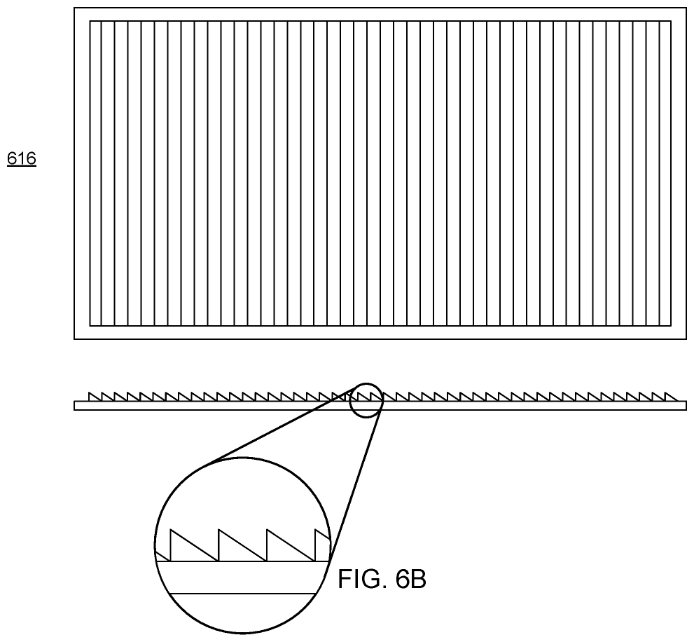

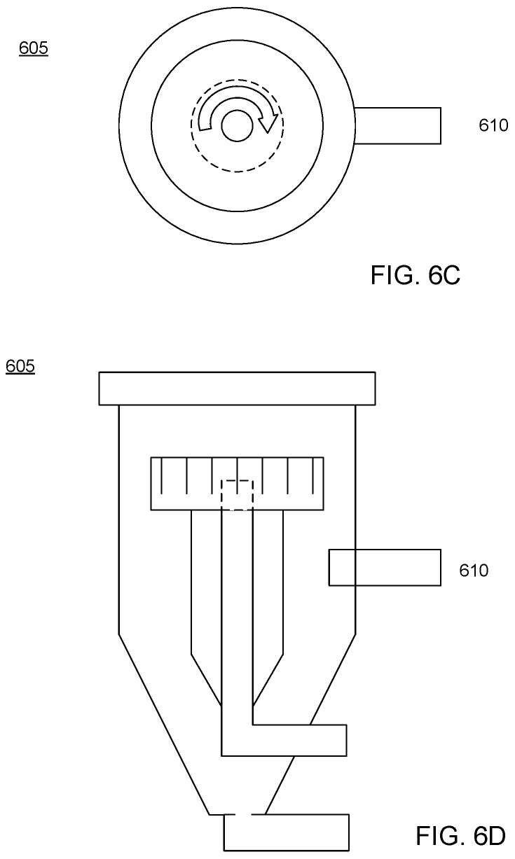

Referring now to FIG. 6, an exemplary biofilter segment 600 of an irrigation filter module is illustrated. In some aspects, a biofilter segment 600 may remove pollutants, bacteria, harmful chemicals, or precipitate, as non-limiting examples. In some embodiments, the spin filter 605 may spin received through the incoming line 610 to begin the separation process, wherein centripetal force may cause a gentle separation of denser components within the water to collect.

In some aspects, water may flow into the biofilter segment 600 from a previous module passively, such as by using gravity; actively, such as through a pump; or a combination thereof. In some embodiments, the water may flow from the spin filter to the biofilter 615, which may be used to filter harmful chemicals, pollutants, or waste, as non-limiting examples. In some implementations, the biofilter 615 may utilize a range of microorganisms, such as plants and small invertebrates, that may naturally breakdown the unwanted components within the water.

Referring now to FIG. 6B, an exemplary biofilter 615 screen is illustrated. In some embodiments, a biofilter 615 may be separate from a biofilter segment 600. For example, the biofilter 615 may be placed into the biofilter segment 615 once ready for installation. Removable biofilters 615 may allow for easy cleaning. In some embodiments, the biofilter 615 may have sharp ridges that may allow for removal of particulate as the water is flowed through the biofilter 615. In some aspects, the biofilter 615 may comprise multiples materials based on the conditions and configuration of the modular hydroponic system. For example, a thicker, more durable material may be used for a modular hydroponic system with a larger volume of recycled water. In some implementations, the quantity and size of the biofilter 615 may be adjusted based on the configuration and size of the modular hydroponic system.

Referring now to FIGS. 6C-6D, an exemplary spin filter 605 is illustrated. In some embodiments, the spin filter 605 may be connected to the incoming line 610, allowing for the direct flow of water from an incoming line to the spin filter 605. In some implementations, the incoming line 610 may be disconnected from the spin filter 605 when being cleaned or altered. For example the incoming line may become dirty or damaged and then the user may then take the incoming line 610 off of the spin filter 605 to solve the problem. In some aspects, the spin filter 605 may spin in one direction, rather than altering directions. For example, the spin filter 605 may be designed to constantly spin the water clockwise, allowing for the separation of particulate from the water.

In some embodiments, there may be more than one incoming line 610 that is connected to the spin filter 605. In some aspects, the spin filter 605 may switch spinning directions when changed manually, and this may increase durability and allow for the forced change of direction in the water, which may increase the separation of particulate from the water. In some embodiments, the modular hydroponic system may comprise a series of hydroponic modules in linked succession, wherein the water from one module flows directly into another in sequence, which may allow for an effective cycle of nutrient-rich water whose nutrients are consistently replenished through an aquaponic module. In some aspects, the series of hydroponic modules may dispense water through an outflow line that may go directly to an irrigation filter system.

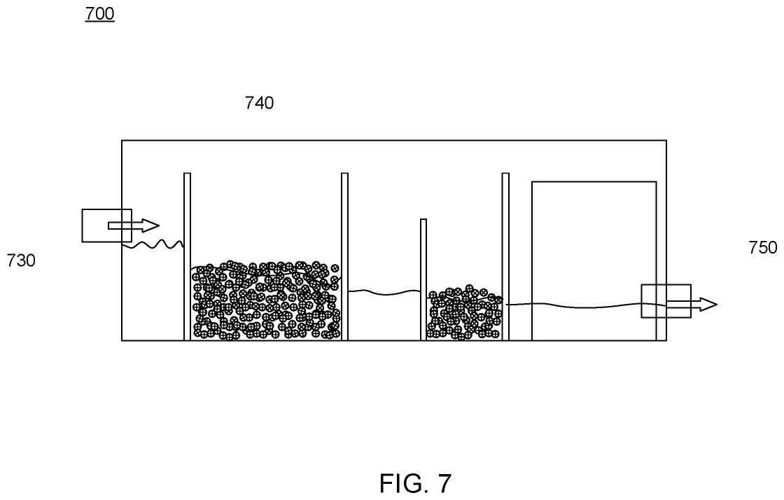

Referring now to FIG. 7, an exemplary bead filter segment 700 of an irrigation filter system is illustrated. In some aspects, a bead filter segment 700 may flow demineralized water from a demineralized line 730 over floating bacteria beads 740. In some embodiments, the floating bacteria beads may remove debris from the demineralized water. In some implementations, the water that may be flowed through the recycling line 750 may be nutrient-rich and ready to irrigate the farming systems within the modular hydroponic system.

In some aspects, the floating bacteria beads 730 may comprise a uniform size or a range of sizes, such as small, medium, or large, but may not be limited to a fixed size, wherein the size may be based on the size and type of debris to be removed. In some implementations, water may pass through multiple sections of floating bacteria beads 730, which may allow for the water to flow at multiple speeds increasing the effectiveness of the floating bacteria beads 730. In some embodiments, the treated water may exit the bead filter segment through a recycling line 750, where newly treated water may flow out of the irrigation filter system and into the next module

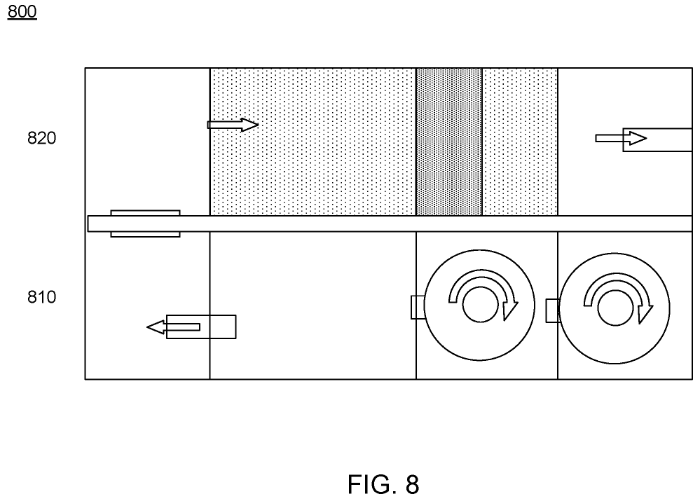

Referring now to FIG. 8, an exemplary irrigation filter module 800 is illustrated, wherein the irrigation filter module 800 may function to maintain a balance of nutrients and bacteria. In some aspects, the irrigation filter module 800 may comprise a biofilter segment 810 that may receive circulated water from a modular hydroponic system, wherein the biofilter segment 810 may remove predefined components of the circulated water. In some implementations, the irrigation filter module 800 may comprise a media filter segment 820 that may receive water treated by the biofilter segment 810, wherein the media filter segment 820 may prepare the water for recirculation into the modular hydroponic system.

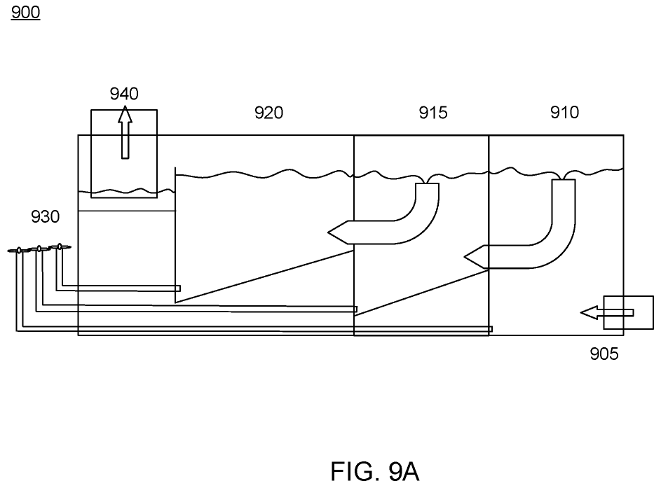

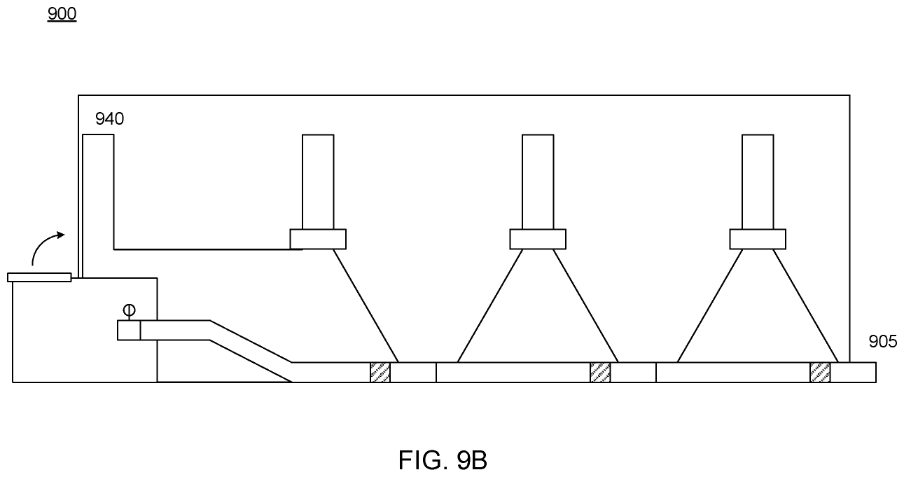

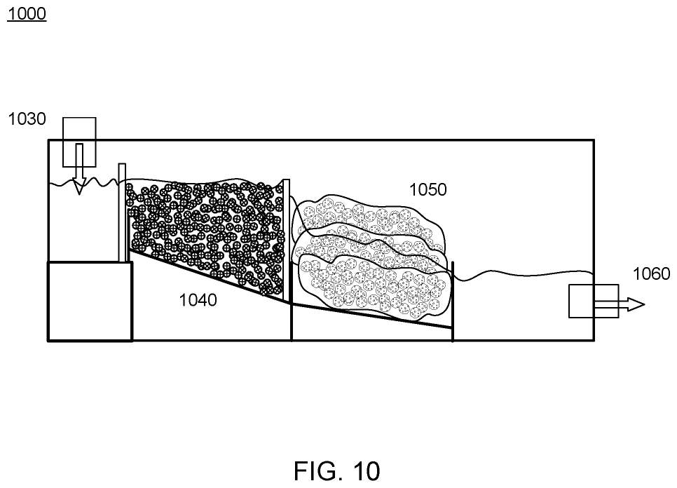

Referring now to FIGS. 9A-9B, an exemplary biofilter segment 900 of an irrigation filter module is illustrated. In some embodiments, a biofilter segment 900 may remove predefined components from circulated water 905, such as pollutants, bacteria, harmful chemicals, or precipitate, as non-limiting examples. In some implementations, the biofilter segment 900 may comprise multiple chambers 910, 915, 920. In some aspects, one or more chambers 910, 915, 920 may comprise a drain 930 to drain fish solids to a mineralization tank. In some embodiments, multiple chambers 910, 915, 920 may slow the flow of water, which may allow the solids to sink to the bottom for ease of separation and removal. In some implementations, the processed water 940 may be flowed into a media filter segment, such as illustrated in FIG. 10.

Referring now to FIG. 10, an exemplary media filter segment 1000 of an irrigation filter system is illustrated. In some aspects, a media filter segment 1000 may flow demineralized water from a demineralized line 1030 over floating bacteria beads 1040 in a first chamber and over rock media bags 1050 in a second chamber. In some embodiments, the media may remove debris from the demineralized water. In some aspects, the rock media bags 1050 may allow bacteria to process the water for recycling into the modular hydroponic system. In some implementations, the media filter segment 1000 may flow the now nutrient-rich water 1060 back into circulation for growing flora and fauna within the modular hydroponic system.

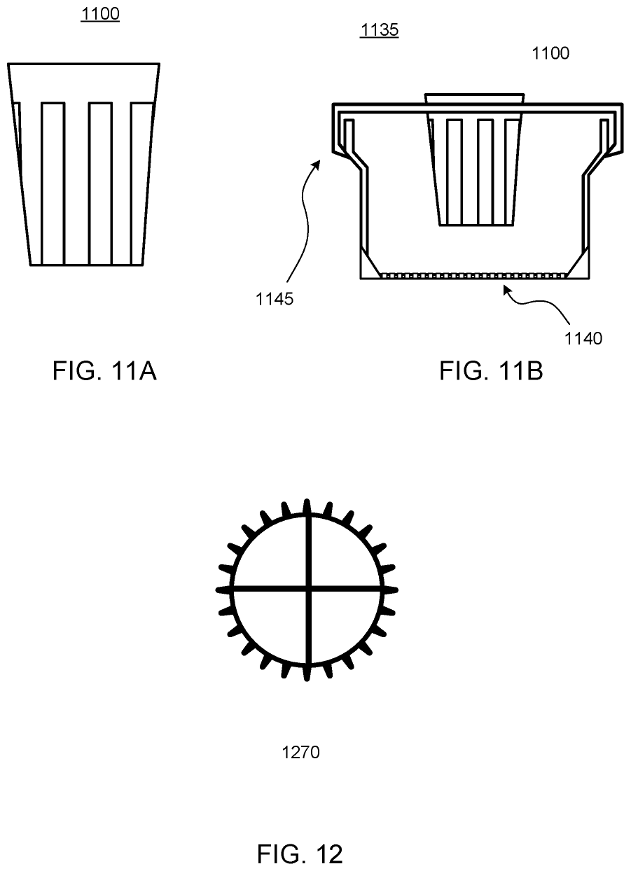

Referring now to FIG. 11A, an exemplary plant pod 1100 is illustrated. In some aspects, plant pods 1100 may contain individual plants, which may allow for easy removal and replacement of plants. In some embodiments, a plant pod 1100 may comprise a series of slots that may allow for the flow of air, nutrients, and water to and from the plant roots. In some implementations, the plant pod 1100 may contain soil and the plant roots, which may allow for sustained moisture surrounding the roots. In some aspects, the slots of a plant pod 1100 may allow a user to harvest the plant and separate it from the roots.

Referring now to FIG. 11B, an exemplary grow bed 1135 with plant pod 1100 is illustrated. In some embodiments, a grow bed 1135 may comprise a removable frame 1145, which may allow for easier cleaning of the grow bed 1135. In some aspects, a removable frame 1145 may allow for replacement of the removable frame 1145 and the base, which may be necessary over time or in the event of damage. In some implementations, the base may comprise flow ridges 1140, which may allow for ease of flow for water. In some embodiments, the flow ridges 1140 may reduce the chance for pooling of water in a particular area of the grow bed 1135.

In some embodiments, the flow ridges 1140 may allow the flow of water to properly allow the roots of the plants to get water, and the flow ridges 1140 may collect water to recycle back into the irrigation system. In some aspects, the removable frame 1145 may be removed to allow for easy clean-up, and this may also be useful to fix something broken, or to keep the inside of the frame from growing mold.

In some implementations, a shallow stream of nutrient-rich water may be recirculated past the bare roots of plants through the grow bed 1135, which may develop a root mat along the flow ridges 1140. In some aspects, the roots extending from the plant pods 1100 may be exposed to an abundant supply of oxygen. In some embodiments, the flow ridges 1140 may be designed to optimize nutrient exposure, such as through channel slope, flow rate, and channel length, as non-limiting examples.

Referring now to FIG. 12, an exemplary floating bacteria bead 1200 is illustrated. In some implementations, water within a modular hydroponic system may be processed through a bundle of floating bacteria beads 1200. In some embodiments, the floating bacteria beads 1200 may be used as a filter for water flowed over the floating bacteria beads 1200, removing solids, bacteria, harmful chemicals, fish waste, and many other pollutants, as non-limiting examples. In some aspects, the shape and size may be customized to the type of components that may need to be removed from the water. Where multiple sizes and shapes may be useful, a mix of floating bacteria beads 1200 may be used. In some implementations, the ratio of each size may depend on the likely concentration of each unwanted component.

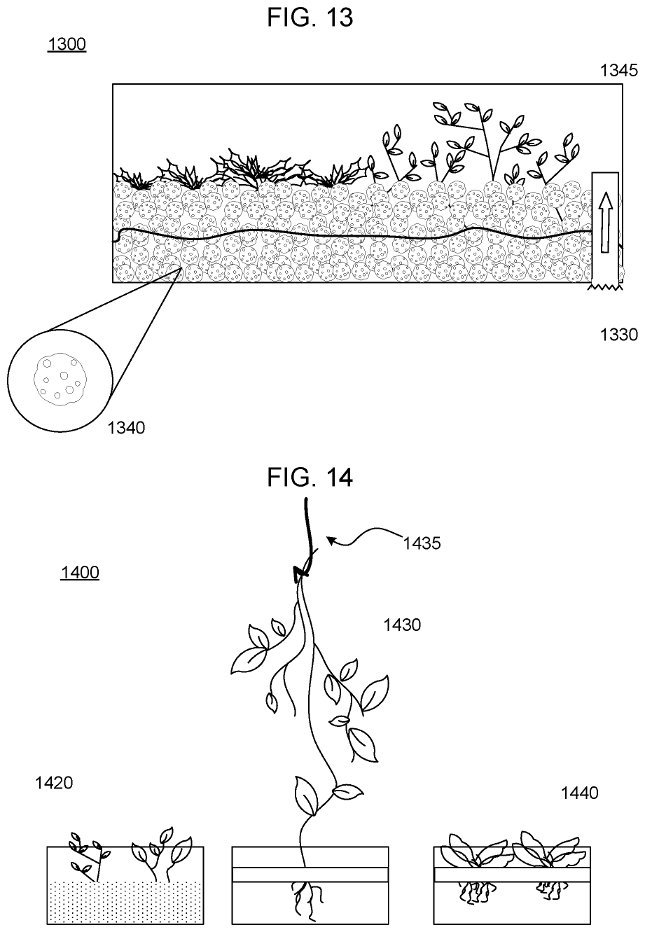

Referring now to FIG. 13, an exemplary passive sub-irrigation module 1300 is illustrated. In some aspects, the passive sub-irrigation module 1300 may include one or more plant types. In some embodiments, an irrigation line 1330 may provide nutrient-filled water received from a previous module into the passive sub-irrigation module 1300. In some implementations, the irrigation line 1330 may be configured to flow water as needed. In some aspects, excess water may flow into the next module, such as where a threshold water line is surpassed.

In some embodiments, the passive sub-irrigation module 1300 utilize clay pellets 1345 to provide moisture to the roots of the plants 1345. In some aspects, a clay pellet 1340 may absorb a predefined volume of water, wherein the size and shape of the clay pellet 1340 may be customized based on the nutrient requirements of the plants 1345. In some implementations, a variety of plants 1345 may grow in a passive sub-irrigation module 1300, wherein the plants 1345 may have similar nutrient and water requirements.

In some aspects, a passive sub-irrigation module 1300 may utilize a method where plants 1345 may be grown in an inert porous medium, such as clay pellets 1340 or coconut husks, that may transport water and nutrients to the roots be capillary action. In some implementations, the inert porous medium may increase air space within the passive sub-irrigation module 1300, which may allow for an increased delivery of oxygen to the roots, which may be particularly significant to some types of plants 1345, such as orchids or bromeliads. In some embodiments, a passive sub-irrigation module 1300 may reduce the chance of root rot.

Referring now to FIG. 14, exemplary mixed grow bed modules 1400 are illustrated, wherein the each grow bed modules 1400 may be custom to grow predefined types of plants. In some aspects, a passive sub-irrigation grow bed 1420 may allow different types of plants to flourish using the clay pellets, such as illustrated in FIG. 13. In some implementations, a vine grow bed 1430 allow for vine type plants to thrive, wherein the vine grow bed 1430 may depend on a range of irrigation types, such as hydroponics, aeroponics, static solution culture, or sub-irrigation, as non-limiting examples. In some embodiments, a vine grow bed 1430 may utilize a vine stabilizer 1435 that may allow for upward growth of the vines. The vine stabilizer 1435 may enable the vine to grow naturally and safely without killing it from the root, and it may support it over its lifetime so that it may get maximum nutrition without breaking or damaging the foundation like soil would with no support.

In some aspects, a static solution grow bed 1440 may allow for plants to float atop the water, limiting root damage and other issues such as root rot. In some embodiments, the plants may be grown in a container of nutrient-rich water, wherein the water may or may not be aerated. Where the water is not aerated, once recollected and recycled back into the modular hydroponic system, the water may need to be oxygenated. Also where the water is not aerated, the water level may be maintained below the root level, which may allow the plants to receive adequate oxygen.

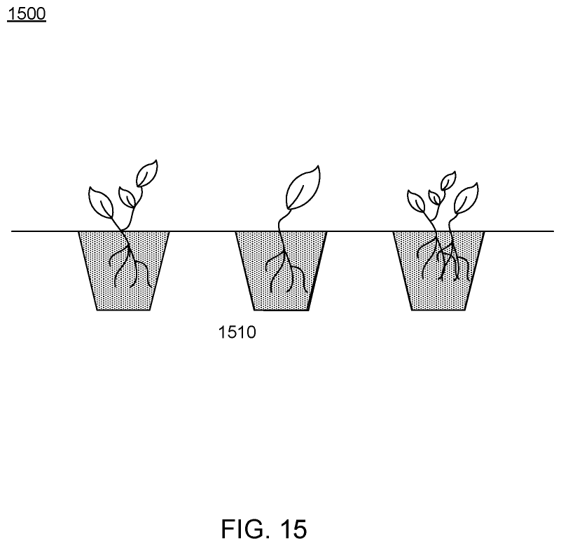

Referring now to FIG. 15, an exemplary grow plug module 1500 are illustrated, wherein the grow plug module 1500 may comprise a plurality of grow plugs 1510. In some implementations, a plant may be grown within a grow plug 1510, similarly as may be grown within soil. In some aspects, a grow plug module 1500 may comprise an organic material may naturally break down and degrade over time. In some embodiments, the grow plug 1510 may comprise a combination of one or more worm castings, organic carbon, gelatin, and zazomite. In some implementations, a degraded grow plug 1510 may be fed to worms, which may allow for a cycle of component production. In some aspects, the grow plug 1510 may sufficiently hold together to allow for growth of a plant within a modular hydroponic system.

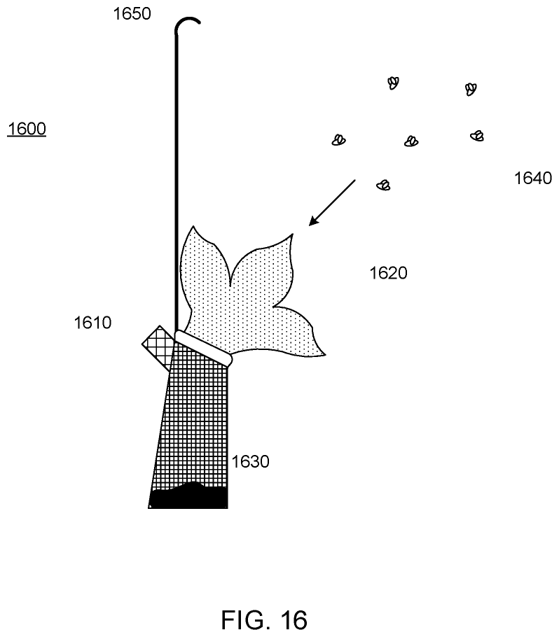

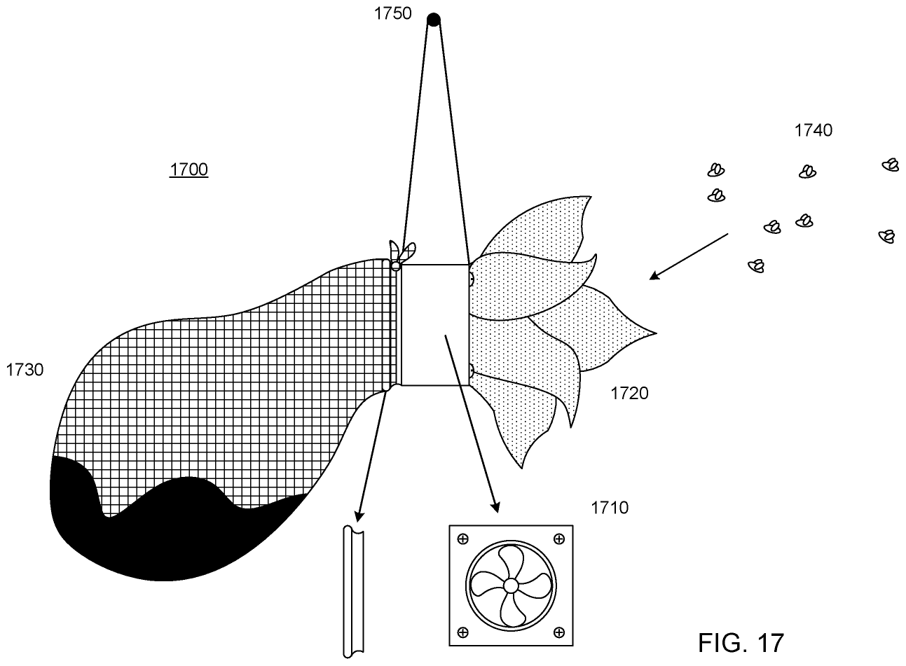

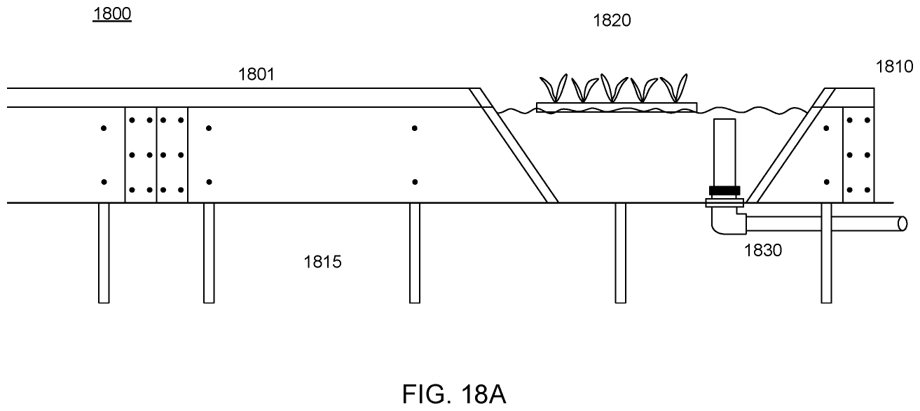

Referring now to FIG. 16, an exemplary fan trap 1600 is illustrated, wherein the fan trap 1600 may be configured to attract and capture pests 1640. In some embodiments, the fan trap 1600 may comprise a connector mechanism 1650 that may secure the fan trap 1600 within a modular hydroponic system, such as suspended from a pillar or ceiling of a modular hydroponic system. In some aspects, the placement of one or more fan traps 1600 may be based on convenience, pest concentration or likelihood, or efficiency of attracting pests 1640. In some embodiments, the fan trap 1600 may comprise a net bag 1630 that may contain collected pests 1640.

In some implementations, the fan trap 1600 may passively attract pests 1640, such as with bait or a static odor. In some aspects, the fan trap 1600 may comprise a flower mouth 1620 that may appear similar to an attracting flower for the pests 1640. In some embodiments, the flower mouth 1620 may comprise a textured or sticky surface, which may provide a secondary method of collecting the pests 1640.

In some aspects, the fan trap 1600 may actively attract pests, such as by periodically releasing a pheromone, which may allow for targeted pest attraction. Where the fan trap 1600 may be active, the fan trap 1600 may comprise a power source, such as a replaceable or rechargeable battery, solar power, wind power, or combinations thereof, as non-limiting examples. In some embodiments, a fan may disperse an attracting substance. In some implementations, the fan trap 1600 may periodically activate, such as every ten minutes. In some aspects, the fan trap 1600 may communicate with sensors within the modular hydroponic system, which may prompt activation of the fan trap 1600 based on predefined parameters.

For example, the sensors may detect the presence of the pests 1640 and trigger activation of the fan trap 1600. As another example, the sensors may detect environment parameters that are conducive to the pests 1640 and trigger activation of the fan trap 1600. As another example, the sensors may detect an abundance of the attracting substance in the air and trigger the fan trap 1600 to stop or lower the dispersing of the attractive substance.

Referring now to FIG. 17, an exemplary fan trap 1700 is illustrated, wherein the fan trap 1700 may be configured to attract and capture pests 1740. In some aspects, the fan trap 1700 may be used to attract and capture pests 1740. In some embodiments, the net bag 1730 may be used to hold the fan trap 1700 and the bait inside the trap. In some implementations, the net bag 1730 may be used to capture everything that enter the device, limiting the ability to exit the net bag 1730. In some aspects, a plant mouth 1720 may stick outside the net bag 1730 and be used to attract pests 1740.

In some embodiments, a fan 1710 may be used to help drive pests 1740 toward the plant mouth 1720. In some aspects, the fan 1710 may be adjust to different levels that blow more or less powerful depending on the desired power. For example, the fan 1710 may be turned up to a higher power when more pests 1740 need to be captured in the plant or the pests 1710 are further away from the plant mouth 1720. As another example, the fan 1710 may be turned down to a lower setting when on for longer periods of time or used to capture a smaller amount of pests 1740.

In some aspects, the fan 1710 may be placed or moved at will to accommodate variations of layouts for the fan trap 1700. In some embodiments, the net bag 1730 may have a ring or clasp round the end near the plant mouth 1720 to secure the plant within the net bag 1730. In some implementations, the clasp-like device may be tightened or loosened based on the size of the plant within the net bag 1720. In some aspects, the clasp-like device may be completely removed from the net bag 1720 to allow for a change in plant mouth 1720, which may be based on what plants are attractive to local pests. For example, the clasp may be take-off of the net bag 1720 and then reinstalled once a new plant mouth 1720 has been inserted. A removable net bag 1720 may allow for easy cleaning and bait replacement.

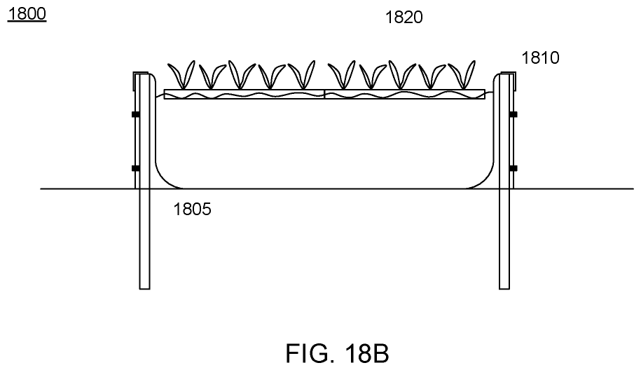

Referring now to FIGS. 18A-18B, an exemplary hydroponic tank module 1800 is illustrated, wherein the hydroponic tank module 1800 comprises a hydroponic tank 1801 with floating grow beds 1820. In some aspects, the hydroponic tank module 1800 may encompass many different devices within the device that help aid to the full production of the process. In some aspects, each device may have its own section within the hydroponic tank 1801 that may allow water flow through the device, which may allow for controlled movement of hydroponic grow beds 1820. In some embodiments, the hydroponic grow bed 1820 may be used to grow predefined plants and flora. In some implementations, utilization of a range of hydroponic grow beds 1820 may allow for a diverse agriculture. Each hydroponic grow bed 1820 type may have its own section within the hydroponic tank 1801, which may allow for effective and efficient growth and management.

In some aspects, the tank anchor 1815 may be used help keep the device and its components anchored down within the system. In some embodiments, a tank frame 1810 may support and provide stability to components within the hydroponic tank module 1800. In some aspects, the tank frame 1810 may be deconstructed and maintain support for each individual component and section throughout the hydroponic tank 1801. In some implementations, the tank frame 1810 may be altered throughout its lifespan in order to adhere to the changes that may be made to the hydroponic tank 1800, such as changes in size and configuration.

In some aspects, the hydroponic tank 1801 may comprise a tank liner 1805, which may provide the water-tight structure to contain the water of the hydroponic tank module 1800. In some embodiments, the tank liner 1805 may comprise a durable material that may limit damage or puncturing to the tank liner 1805. In some implementations, the tank liner 1805 may extend to the exterior ground surrounding the hydroponic tank module 1800, which may limit exposure of the tank frame 1810 to ambient and environmental conditions. For example, a tank liner 1805 may limit the development of rust or deterioration of the tank frame 1810.

In some aspects, the material used to make the different components of the device may vary based on amount of usage, type of usage, configuration of the modular hydroponic system, and conditions of the ambient environment, as non-limiting factors. For example, where the modular hydroponic system may be located within a controlled environment, the materials may be based on the conditions of the controlled environment, which may be less severe than an open environment. As another example, the modular hydroponic system may be located in a desert area, wherein the controlled environment may control the air quality and not the temperature. This may require durable materials through the modulate hydroponic system and may benefit from a temperature control system for each module. In some aspects, the material the tank liner 1810 may be based on the water characteristics held within the hydroponic tank module, the usage of the hydroponic tank 1801, and the material of the hydroponic tank 1801, as non-limiting examples.

In some aspects, the tank liner 1805 may attach to the hydroponic tank 1801 and create a water barrier to contain the water within the tank. In some embodiments, the tank liner 1805 may attach via an adhesive material that connects the bottom of the tank liner 1805 to the interior of the hydroponic tank 1801. In some implementations, the tank liner 1805 may connect via a snapping system that snaps the liner into place on the interior of the hydroponic tank 1801. In some aspects, the hydroponic tank 1801 may have an outflow pipe 1830 that allows for the outflow of water back into the recycling irrigation system.

In some embodiments, the outflow pipe 1830 may be detached from the modular hydroponic system during deconstruction or cleaning, allowing for draining of the water. In some aspects, the outflow pipe 1830 may be permanently attached to the hydroponic tank 1801, or it may be detached when being cleaned or transferred. In some embodiments, the outflow pipe 1830 may come in different sizes and lengths depending on the variation needed for specific use. For example, a longer or larger diameter may allow for an increased volume of water flow.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A modular hydroponic system comprising:
an interconnected series of hydroponic modules, the series are linked through a recycling irrigation system, the series of hydroponic modules comprising at least:
a hydroponic tank module comprising:
a hydroponic intake pipe that accepts water from the recycling irrigation system,
a hydroponic water tank configured to hold water,
a tank liner attached to the water tank, wherein the tank liner contains the water within the hydroponic water tank,
one or more hydroponic grow beds configured to hold plants, wherein roots of inserted plants are in contact with the water in the hydroponic water tank, a hydroponic outflow pipe that provides water to the recycling irrigation system;
an aquaponic module comprising:
an aquaponic intake pipe that accepts water from the recycling irrigation system,
at least one aquaponic water tank configured to hold water,
a plurality of fish in the at least one aquaponic water tank providing nutrients to the water, wherein the plurality of fish are held for a predefined duration and stage of growth,
an aquaponic outflow pipe that provides water to the recycling irrigation system;
an aeroponic module comprising:
an aeroponic intake pipe that accepts water from the recycling irrigation system,
a moisture supply line configured to expel moisture,
one or more plant holder configured to hold plants, wherein roots of inserted plants are expose to moisture,
an aeroponic outflow pipe that provides water to the recycling irrigation system; and
an irrigation filter module comprising:
an irrigation filter intake pipe that accepts water from the recycling irrigation system,
one or more biofilters, each configured to remove predefined components from the water, wherein flowing water from the irrigation filter intake pipe through the one or more biofilter removes at least a portion of predefined components,
an irrigation filter outflow pipe that provides water to the recycling irrigation system, wherein water flowing out through the irrigation filter outflow pipe is nutrient-rich and balanced to contribute to growth of plants in the modular hydroponic system.

2. The modular hydroponic system, wherein the water is on a closed loop.

3. The modular hydroponic system of claim 1, wherein the hydroponic grow beds float on top of the water in the hydroponic water tank.

4. The modular hydroponic system of claim 1, wherein at least a portion of the series of hydroponic modules comprise a temperature regulator that controls a water temperature within the portion of the series of hydroponic modules.

5. The modular hydroponic system of claim 1, wherein the irrigation filter module further comprises a spin filter, wherein the spin filter separates denser components within the water through centripetal force.

6. The modular hydroponic system of claim 1, wherein the biofilter comprises a plurality of filter screens.

7. The modular hydroponic system of claim 1, wherein the irrigation filter module processes the water through demineralization.

8. The modular hydroponic system of claim 1, wherein the recycling irrigation system comprises a series of connector pipes that flow water between modules.

9. The modular hydroponic system of claim 8, wherein the aquaponic module immediately precedes the irrigation filter module, wherein water flows out of the aquaponic outflow pipe into the irrigation filter module through the irrigation filter intake pipe.

10. The modular hydroponic system of claim 1, further comprising:
a holding module comprising a holding tank configured to temporarily hold fish before transfer to or after transfer from the aquaponic module.

11. The modular hydroponic system of claim 10, wherein the holding module temporarily holds fish at one or both fry and juvenile stages.

12. The modular hydroponic system of claim 11, wherein the aquaponic tank further comprises a fry screen that limits the entry of fish from the holding tank prior to adulthood.

13. The modular hydroponic system of claim 1, wherein the series of hydroponic modules are contained within a controlled environment.

14. The modular hydroponic system of claim 13, further comprising an environment regulator module configured to monitor and control one or more environmental conditions.

15. The modular hydroponic system of claim 14, wherein the water is supplemented by moisture extracted from the ambient air within the controlled environment.

16. The modular hydroponic system of claim 14, wherein the environment regulator module monitors temperature.

17. The modular hydroponic system of claim 1, further comprising a passive sub-irrigation module, wherein the passive sub-irrigation module comprises:
a sub-irrigation intake pipe that accepts water from the recycling irrigation system,
one or more sub-irrigation grow beds configured to contain media and a plurality of plants, wherein at least a portion of roots of the plants are within the media,
a water supply line configured to passively provide water to the one or more sub-irrigation grow beds, wherein the media retains at least a portion of the water,
one or more plant holder configured to hold plants, wherein roots of inserted plants are expose to moisture,
a sub-irrigation outflow pipe that provides water to the recycling irrigation system

18. The modular hydroponic system of claim 17, wherein the passive sub-irrigation module is integrated with the aeroponic module.

19. The modular hydroponic system of claim 1, wherein the irrigation filter module further comprises a collection of floating bacteria beads that remove predefined bacteria of the water as water flows through the collection of floating bacteria beads.

20. The modular hydroponic system of claim 19, wherein the collection of floating bacteria beads is separated into a plurality of chambers within the irrigation filter module, wherein water is flowed through the plurality of chambers, each removing at least a portion of predefined bacteria.
